(19) United States
(12) Patent Application Publication
(10) Pub. No.: US 2013/0117054 A1
(43) Pub. Date: May 9, 2013

(54) TRANSPORTATION NETWORK SCHEDULING SYSTEM AND METHOD

(71) Applicants: Jared Cooper, Melbourne, FL (US); Joseph Noffsinger, Grain Valley, MO (US); Ajith Kuttannair Kumar, Erie, PA (US); Mason Samuels, Melbourne, FL (US); Paul Houpt, Niskayuna, NY (US)

(72) Inventors: Jared Cooper, Melbourne, FL (US); Joseph Noffsinger, Grain Valley, MO (US); Ajith Kuttannair Kumar, Erie, PA (US); Mason Samuels, Melbourne, FL (US); Paul Houpt, Niskayuna, NY (US)

(21) Appl. No.: 13/288,226

(22) Filed: Nov. 3, 2011

(51) Int. Cl. G06Q 10/06

(52) U.S. Cl. 705/7.12

(57) ABSTRACT

A system includes a scheduling module and a monitoring module. The scheduling module is configured to generate schedules for vehicles to concurrently travel in a transportation network formed of interconnected routes over which the vehicles travel. The monitoring module is configured to determine financial costs of fuel at refueling locations within the transportation network that are used by one or more of the vehicles to acquire additional fuel. The scheduling module is configured to coordinate the schedules of the vehicles based on the financial costs of the fuel while maintaining a throughput parameter of the transportation network above a designated threshold. The throughput parameter represents adherence by the vehicles to the schedules as the vehicles travel through the transportation network.

### FIELD OF THE INVENTION

Embodiments of the invention relate to scheduling systems for vehicles traveling in a transportation network.

### BACKGROUND OF THE INVENTION

A transportation network for vehicles can include several interconnected main routes on which separate vehicles travel between locations. For example, a transportation network may be formed from interconnected railroad tracks with rail vehicles traveling along the tracks. The vehicles may travel according to schedules that dictate where and when the vehicles are to travel in the transportation network. The schedules may be coordinated with each other in order to arrange for certain vehicles to arrive at various locations in the transportation network at desired times and/or in a desired order.

As the vehicles travel through the transportation network, one or more vehicles may need to refuel to have sufficient fuel to reach the scheduled destinations of the vehicles. Different facilities that sell fuel may provide the fuel at different costs, depending on a variety of factors, including accessibility of the facilities, taxes, and other costs involved in providing the fuel. Known scheduling systems that create the schedules for the vehicles to travel in the transportation network usually schedule the vehicles to travel at a speed limit, such as a track speed, in order to arrive at associated destination locations as quickly as possible. Traveling at the speed limits, however, may limit the options available for the vehicles in refueling. For example, some vehicles may not have sufficient fuel to reach a less expensive refueling facility when the vehicles travel at the speed limit. As a result, the costs of operating the vehicles can be greater than necessary. Traveling below the speed limits, however, can cause delays in the travel of other vehicles in the transportation network where the schedules of these other vehicles are based on each other.

A need exists for a scheduling system and method that coordinates schedules of vehicles concurrently traveling in a transportation network. Such a system and method may reduce costs of operating the vehicles by scheduling the vehicles to refuel at lower cost refueling facilities, while avoiding increasing traffic congestion in the transportation network.

### BRIEF DESCRIPTION OF THE INVENTION

In one embodiment, a system includes a scheduling module and a monitoring module. As used herein, the term “module” includes a hardware and/or software system that operates to perform one or more functions. For example, a module may include a computer processor, controller, or other logic-based device that performs operations based on instructions stored on a tangible and non-transitory computer readable storage medium, such as a computer memory. Alternatively, a module may include a hard-wired device that performs operations based on hard-wired logic of the device. The modules shown in the attached figures may represent the hardware that operates based on software or hardwired instructions, the software that directs hardware to perform the operations, or a combination thereof.

The scheduling module is configured to generate schedules for vehicles to concurrently travel in a transportation network formed of interconnected routes over which the vehicles travel. The monitoring module is configured to determine financial costs of fuel at refueling locations within the transportation network that are used by one or more of the vehicles to acquire additional fuel. As used herein, the term “determine” may include active action, such as by the monitoring module acquiring the financial costs, and/or passive action, such as by the monitoring module receiving the financial costs from another source. The scheduling module is configured to coordinate the schedules of the vehicles based on the financial costs of the fuel while maintaining a throughput parameter of the transportation network above a designated threshold. The throughput parameter represents adherence by the vehicles to the schedules as the vehicles travel through the transportation network.

In another embodiment, a method includes determining financial costs of fuel at refueling locations within a transportation network formed of interconnected routes over which vehicles travel and generating schedules for the vehicles to concurrently travel in the transportation network. One or more of the schedules includes a refueling stop for one or more of the vehicles at one or more of the refueling locations. The schedules are generated by coordinating the schedules with each other based on financial costs of the fuel at the refueling locations while maintaining a throughput parameter of the transportation network above a non-zero threshold, the throughput parameter representative of adherence by the vehicles to the schedules as the vehicles travel through the transportation network.

In another embodiment, another system includes an energy management module and a control module. The energy management module is configured to be disposed on-board a vehicle that travels in a transportation network formed from interconnected routes. The energy management module also is configured to generate a trip plan for a control unit of the vehicle that is used to control tractive efforts of the vehicle as the vehicle travels in the transportation network. The control module is configured to track an amount of fuel carried by the vehicle and to communicate the amount of fuel to a network scheduling system. The energy management module also is configured to generate the trip plan based on a schedule that is received from the network scheduling system and that is based on the amount of fuel tracked by the control module. The trip plan directs the vehicle to stop to refuel at one or more refueling locations in the transportation network based on financial costs of the fuel provided by the one or more refueling locations.

### BRIEF DESCRIPTION OF THE DRAWINGS

The present inventive subject matter will be better understood from reading the following description of non-limiting embodiments, with reference to the attached drawings, wherein below:

FIG. 1 is a schematic diagram of one embodiment of a transportation network;

FIG. 2 is a schematic diagram of one embodiment of a scheduling system and a control system shown in FIG. 1;

FIG. 3 is a schematic diagram of a portion of the transportation network shown in FIG. 1 in accordance with one embodiment;

FIG. 4 illustrates examples of velocity curves for a vehicle traveling in the portion of the transportation network shown in FIG. 3;

FIG. 5 illustrates examples of other velocity curves for the vehicle traveling in the portion of the transportation network shown in FIG. 3;

FIG. 6 is a schematic diagram of another portion of the transportation network shown in FIG. 1 in accordance with one embodiment;

FIG. 7 illustrates examples of velocity curves for the vehicle traveling in the portion of the transportation network shown in FIG. 6; and

FIG. 8 is a flowchart of one embodiment of a method for scheduling travel of vehicles in a transportation network based on fuel costs and throughput parameters of the transportation network.

### DETAILED DESCRIPTION OF THE INVENTION

One or more embodiments of the inventive subject matter described herein provide systems for coordinating schedules of vehicles traveling in a transportation network based on fuel costs (e.g., costs associated with refueling the vehicles) at various locations or areas in the transportation network or in another transportation network. The schedules may be coordinated in order to maintain one or more throughput parameters of the transportation network above a predetermined threshold, such as a non-zero threshold. As described below, the throughput parameter may represent a measurement of flow of the vehicles through the transportation network or one or more areas within the transportation network. The schedules can be coordinated by creating and/or modifying the schedules for the vehicles based on the schedules of other vehicles and/or fuel costs. By coordinating the schedules based on fuel costs while keeping the throughput parameter above a predetermined threshold, the vehicles may be able to travel in or through the transportation network without significant congestion and while reducing the fuel costs involved in moving the vehicles.

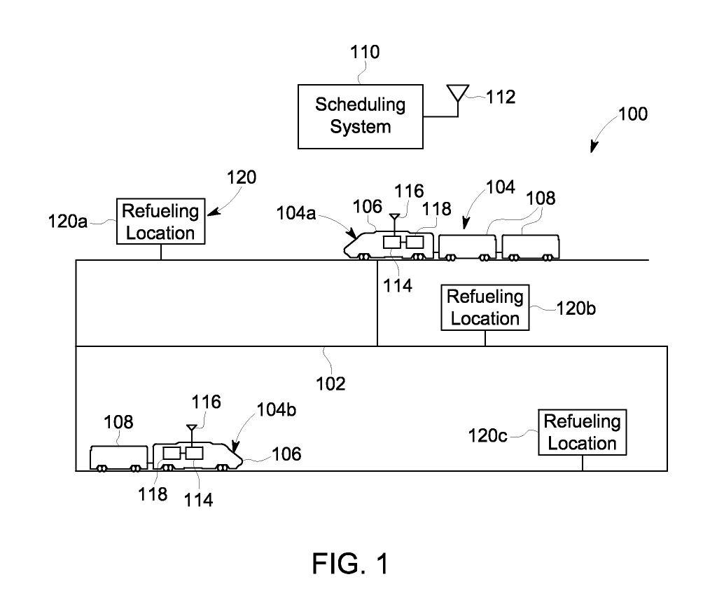

FIG. 1 is a schematic diagram of one embodiment of a transportation network 100. The transportation network 100 includes a plurality of interconnected routes 102, such as railroad tracks, roads, or other paths across which vehicles travel. The transportation network 100 may extend over a relatively large area, such as hundreds of square miles or kilometers of land area. While only one transportation network 100 is shown in FIG. 1, one or more other transportation networks 100 may be joined with and accessible to vehicles traveling in the illustrated transportation network 100. For example, one or more of the routes 102 may extend to another transportation network 100 such that vehicles can travel between the transportation networks 100. Different transportation networks 100 may be defined by different geographic boundaries, such as different towns, cities, counties, states, groups of states, countries, continents, and the like. The number of routes 102 shown in FIG. 1 is meant to be illustrative and not limiting on embodiments of the described subject matter. Moreover, while one or more embodiments described herein relate to a transportation network formed from railroad tracks, not all embodiments are so limited. One or more embodiments may relate to transportation networks in which vehicles other than rail vehicles travel.

Several vehicles 104 travel along the routes 102 in the transportation network 100. The vehicles 104 may concurrently travel in the transportation network 100 along the same or different routes 102. Travel of one or more vehicles 104 may be constrained to travel within the transportation network 100 (referred to herein as “intra-network travel”). Alternatively, one or more of the vehicles 104 may enter the transportation network 100 from another transportation network or leave the transportation network 100 to travel into another transportation network (referred to herein as “inter-network travel”). In the illustrated embodiment, the vehicles 104 are shown and described herein as rail vehicles or rail vehicle consists. However, one or more other embodiments may relate to vehicles other than rail vehicles or rail vehicle consists. The vehicles 104 are individually referred to by the reference numbers 104a and 104b. While two vehicles 104 are shown in FIG. 1, alternatively, a different number of vehicles 104 may be concurrently traveling in the transportation network 100.

A vehicle 104 may include a group of powered units 106 (e.g., locomotives or other vehicles capable of self-propulsion) and/or non-powered units 108 (e.g., cargo cars, passenger cars, or other vehicles incapable of self-propulsion) that are mechanically coupled or linked together to travel along the routes 102. The routes 102 are interconnected to permit the vehicles 104 to travel over various combinations of the routes 102 to move from a starting location to a destination location.

The vehicles 104 may travel along the routes 102 according to a movement plan of the transportation network 100. The movement plan coordinates movement of the vehicles 104 in the transportation network 100. For example, the movement plan may include schedules for the vehicles 104 to move from a starting location or a current location to a destination location at a scheduled arrival time. Each schedule may dictate a destination location and the scheduled arrival time for a vehicle 104. Alternatively, the schedule may include one or more intermediate events for the vehicle 104 prior to reaching the destination location at the scheduled arrival time, such as a location and/or time for the vehicle 104 to stop and refuel.

In one embodiment, the movement plan includes a list, table, or other logical arrangement of scheduled geographic locations (e.g., Global Positioning System coordinates) within the transportation network 100 and associated scheduled arrival times. The vehicles 104 move along various paths within the transportation network 100 to arrive at the scheduled locations at the associated scheduled arrival times. The scheduled locations in the movement plan can be referred to as “scheduled waypoints.”

The movement plan can be based on starting locations or current locations, and/or destination locations of the vehicles 104. For example, a schedule may be developed for one or more of the vehicles 104 that directs the vehicle 104 where and when to move within the transportation network 100 to arrive at a destination from the starting location or current location of the vehicle 104. In one embodiment, a schedule for a vehicle 104 includes a destination location and a scheduled arrival time. The vehicle 104 may travel according to the schedule to arrive at the destination location at the scheduled arrival time. In another embodiment, a schedule for a vehicle 104 may include several scheduled waypoint locations located between the starting location or the current location of the vehicle 104 and a destination location of the vehicle 104, along with scheduled arrival tunes associated with the waypoint locations.

The movement plan may be determined by a scheduling system 110. As shown in FIG. 1, the scheduling system 110 can be disposed off-board (e.g., outside) of the vehicles 104. For example, the scheduling system 110 may be disposed at a central dispatch office for a railroad company. The scheduling system 110 can create and communicate the schedules to the vehicles 104. The scheduling system 110 can include a wireless antenna 112 (and associated transceiving equipment), such as a radio frequency (RF) or cellular antenna, that wirelessly transmits the schedules to the vehicles 104. For example, the scheduling system 110 may transmit destination locations and associated arrival times to the vehicles 104.

The vehicles 104 include control systems 114 disposed on-board the vehicles 104. The control systems 114 receive the schedules from the scheduling system 110 and generate control signals that may be used to control propulsion of the vehicles 104 through the transportation network 100. For example, the vehicles 104 may include wireless antennas 116 (and associated transceiving equipment), such as RF or cellular antennas, that receive the schedules from the scheduling system 110. The wireless antenna 116 communicates the received schedule to the control system 114 that may be disposed on-board the vehicle 104. The control system 114 examines the schedule, such as by determining the scheduled destination location and scheduled arrival time, and generates control signals based on the schedule.

The control signals may be used to automatically control tractive efforts and/or braking efforts of the vehicle 104 such that the vehicle 104 self-propels along the routes 102 to the destination location. For example, the control system 114 may be operatively coupled with a propulsion subsystem 118 of the vehicle 104. The propulsion subsystem 118 may include motors (such as traction motors), engines, brakes (such as air brakes and/or regenerative brakes), and the like, that generate tractive energy to propel the vehicle 104 and/or slow movement of the vehicle 104. The control system 114 may generate control signals that automatically control the propulsion subsystem 118, such as by automatically changing throttle settings and/or brake settings of the propulsion subsystem 118. (Self-propulsion includes automatic operation under the purview of an operator, who may have the option to take over manual control of the vehicle.)

In another embodiment, the control signals may be used to prompt an operator of the vehicle 104 to manually control the tractive efforts and/or braking efforts of the vehicle 104. For example, the control system 114 may include an output device, such as a computer monitor, touchscreen, acoustic speaker, or the like, that generates visual and/or audible instructions based on the control signals. The instructions may direct the operator to manually change throttle settings and/or brake settings of the propulsion subsystem 118.

The control system 114 may form a trip plan for a trip of the vehicle 104 to travel to a scheduled destination location at a scheduled arrival time. The trip plan may include throttle settings, brake settings, designated speeds, or the like, of the vehicle 104 for various sections of the trip of the vehicle 104. For example, the trip plan can include one or more velocity curves that designate various speeds of the vehicle 104 along various sections of the routes 102. The trip plan can be formed based on a trip profile associated with an upcoming trip of a vehicle 104. The trip profile can include information related to the vehicle 104, the routes 102 over which the vehicle 104 will traverse during the upcoming trip, and/or other information. The information related to the vehicle 104 can include the type of vehicle 104, the tractive energy generated by powered units 106 in the vehicle 104, the weight or mass of the vehicle 104 and/or cargo being carried by the vehicle 104, the length and/or other size of the vehicle 104 (e.g., how many powered and non-powered units 106, 108 are mechanically coupled with each other in the vehicle 104), and the like. The information related to the route 102 can include the curvature, grade (e.g., inclination), existence of ongoing repairs, speed limits, and the like, for one or more sections of the route 102. The other information can include information related to conditions that impact how much fuel the vehicles 104 consume while traveling, such as the air pressure, temperature, humidity, and the like. The control system 114 may form the control signals based on the trip plan.

In one embodiment, the trip plan is formed by the control system 114 to reduce an amount of fuel that is consumed by the vehicle 104 as the vehicle 104 travels to the destination location associated with the received schedule. The control system 114 may create a trip plan having throttle settings, brake settings, designated speeds, or the like, that propels the vehicle 104 to the scheduled destination location in a manner that consumes less fuel than if the vehicle 104 traveled to the scheduled destination location in another manner. As one example, the vehicle 104 may consume less fuel in traveling to the destination location according to the trip plan than if the vehicle 104 traveled to the destination location while traveling at another predetermined speed, such as the maximum allowable speed of the routes 102 (which may be referred to as “track speed”). The trip plan may result in the vehicle 104 arriving at the scheduled destination later than the scheduled arrival time. For example, following the trip plan may cause the vehicle 104 to arrive later than the scheduled arrival time, but within a predetermined range of time after the scheduled arrival time.

The transportation network 100 includes several refueling locations 120. The refueling locations 120 are individually referred to by the reference numbers 120a, 120b, 120c, and so on. While three refueling locations 120 are shown, alternatively, the transportation network 100 may include a different number of refueling locations 120. The refueling locations 120 represent facilities where one or more of the vehicles 104 can obtain additional fuel. The vehicles 104 may stop at the refueling locations 120 to refuel as the vehicles 104 travel in or through the transportation network 100.

Different refueling locations 120 may be associated with different fuel costs. For example, the refueling location 120a may sell the same fuel at a greater cost per unit volume than the refueling location 120b and/or 120c. The refueling location 120c may sell the fuel at a lower cost than the refueling location 120b. In one embodiment, different refueling locations 120 may offer different types of fuel. For example, the refueling locations 120a and 120c may sell only diesel fuel, while the refueling location 120b may sell both diesel fuel and natural gas as a fuel.

The cost of refueling at different refueling locations 120 may vary due to different labor costs. For example, a refueling location 120 that includes a fuel pad that allows for relatively fast refueling of locomotives may be associated with reduced labor required to refuel and lower labor costs. As a result, the fuel may be less expensive than other refueling locations 120. As one example, a refueling location 120 that uses a refueling tanker truck to drive next to a locomotive or other vehicle to refuel the locomotive or vehicle may require relatively more labor than a refueling pad and, as a result, increased labor costs and costs of fuel. Other factors may vary the costs of fuel, such as different tax rates, regulations, and the like, imposed on different refueling locations 120, or the geographic location or supply source of the fuel(s).

The scheduling system 110 can coordinate the schedules of the vehicles 104 based on the fuel costs associated with the refueling locations 120. For example, the scheduling system 110 can create and/or modify the schedule of each of several vehicles 104 traveling in the transportation network 100 based on the schedules of one or more other vehicles 104. The schedules may be based on the cost of the vehicles 104 refueling at the different refueling locations 120. The schedules also may be coordinated so that a throughput parameter of the transportation network 100 is maintained above a predetermined non-zero threshold. By coordinating the schedules based on fuel costs while keeping the throughput parameter above a predetermined threshold, the vehicles 104 may be able to travel in or through the transportation network 100 without significantly decreasing the flow of the vehicles 104 in the transportation network 100 while reducing the fuel costs associated with travel of the vehicles 104.

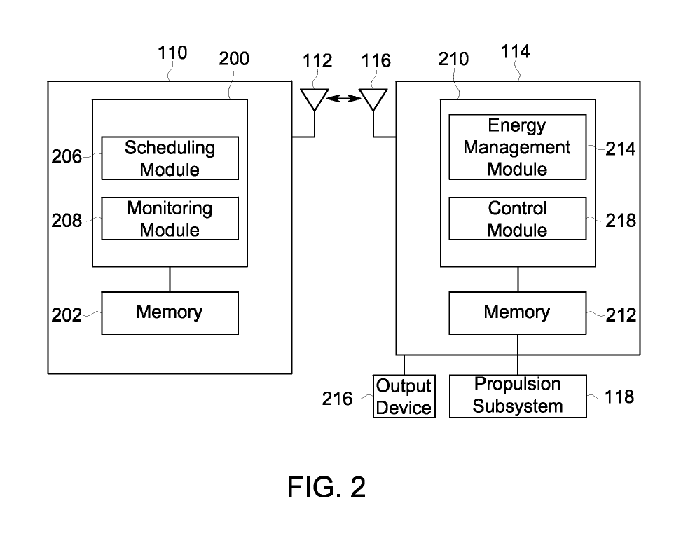

FIG. 2 is a schematic diagram of one embodiment of the scheduling system 110 and the control system 114. While the scheduling system 110 is shown in FIG. 2 as communicating with a single control system 114, in one embodiment, the scheduling system 110 can concurrently communicate with two or more control systems 114 disposed on-board two or more different (e.g., not mechanically coupled with each other) vehicles 104 (shown in FIG. 1).

The scheduling system 110 includes a controller 200, such as a computer processor or other logic-based device that performs operations based on one or more sets of instructions (e.g., software). The instructions on which the controller 200 operates may be stored on a tangible and non-transitory (e.g., not a transient signal) computer readable storage medium, such as a memory 202. The memory 202 may include one or more computer hard drives, flash drives, RAM, ROM, EEPROM, and the like. Alternatively, one or more of the sets of instructions that direct operations of the controller 200 may be hard-wired into the logic of the controller 200, such as by being hard-wired logic formed in the hardware of the controller 200.

The scheduling system 110 includes several modules that perform various operations described herein. The modules are shown as being included in the controller 200. As described above, the modules may include hardware and/or software systems that operate to perform one or more functions, such as the controller 200 and one or more sets of instructions. Alternatively, one or more of the modules may include a controller that is separate from the controller 200.

The scheduling system 110 includes a scheduling module 206 that creates schedules for the vehicles 104 (shown in FIG. 1). In one embodiment, the scheduling module 206 controls communication between the scheduling system 110 and the vehicles 104. For example, the scheduling module 206 may be operatively coupled with the antenna 112 to permit the scheduling module 206 to control transmission of data (e.g., schedules) to the vehicles 104 and to receive data (e.g., trip plans, amounts of fuel carried by the vehicles 104, or the like) from the vehicles 104. Alternatively, another module or the controller 200 may be operatively coupled with the antenna 112 to control communication with the vehicles 104.

The scheduling module 206 creates schedules for the vehicles 104 (shown in FIG. 1). The scheduling module 206 can form the movement plan for the transportation network 100 (shown in FIG. 1) that coordinates the schedules of the various vehicles 104 traveling in the transportation network 100. For example, the scheduling module 206 may generate schedules for the vehicles 104 that are based on each other so that a throughput parameter of the transportation network 100 remains above a threshold.

The throughput parameter can represent the flow or movement of the vehicles 104 through the transportation network 100 or a subset of the transportation network 100. In one embodiment, the throughput parameter can indicate how successful the vehicles 104 are in traveling according to the schedule associated with each vehicle 104. For example, the throughput parameter can be a statistical measure of adherence by one or more of the vehicles 104 to the schedules of the vehicles 104 in the movement plan. The term “statistical measure of adherence” can refer to a quantity that is calculated for a vehicle 104 and that indicates how closely the vehicle 104 is following the schedule associated with the vehicle 104. Several statistical measures of adherence to the movement plan may be calculated for the vehicles 104 traveling in the transportation network 100.

In one embodiment, larger throughput parameters represent greater flow of the vehicles 104 through the transportation network 100, such as what may occur when a relatively large percentage of the vehicles 104 adhere to the associated schedules and/or the amount of congestion in the transportation network 100 are relatively low. Conversely, smaller throughput parameters may represent reduced flow of the vehicles 104 through the transportation network 100. The throughput parameter may reduce in value when a lower percentage of the vehicles 104 follow the associated schedules and/or the amount of congestion in the transportation network 100 is relatively large. Examples of how the throughput parameter may be calculated are described below.

The scheduling module 206 can create and/or modify the schedules of the vehicles 104 (shown in FIG. 1) such that one or more throughput parameters of the vehicles 104 traveling in the transportation network 100 (shown in FIG. 1) are maintained above a predetermined non-zero threshold. For example, the scheduling module 206 can coordinate the initial schedules such that the congestion (e.g., density per unit area over a time window) of the vehicles 104 in one or more portions of the transportation network 100 remains relatively low such that the flow of the vehicles 104 in or through the transportation network 100 is relatively high.

The scheduling system 110 includes a monitoring module 208 in the illustrated embodiment. The monitoring module 208 can monitor travel of the vehicles 104 (shown in FIG. 1) in the transportation network 100 (shown in FIG. 1). The vehicles 104 may periodically report current positions of the vehicles 104 to the scheduling system 110 so that the monitoring module 208 can track where the vehicles 104 are located. Alternatively, signals or other sensors disposed alongside the routes 102 (shown in FIG. 1) of the transportation network 100 can periodically report the passing of vehicles 104 by the signals or sensors to the scheduling system 110. The monitoring module 208 receives the locations of the vehicles 104 in order to monitor where the vehicles 104 are in the transportation network 100 over time.

The monitoring module 208 may determine the throughput parameters of the transportation network 100 (shown in FIG. 1) and/or areas of the transportation network 100 that are used by the scheduling module 206 to coordinate the schedules of the vehicles 104 (shown in FIG. 1). The monitoring module 208 can calculate the throughput parameters based on the schedules of the vehicles 104 and deviations from the schedules by the vehicles 104. For example, in order to determine a statistical measure of adherence to the schedule associated with a vehicle 104, the monitoring module 208 may monitor how closely the vehicle 104 adheres to the schedule as the vehicle 104 travels in the transportation network 100 (shown in FIG. 1). The vehicle 104 may adhere to the schedule of the vehicle 104 by proceeding along a path toward the scheduled destination such that the vehicle 104 will arrive at the scheduled destination at the scheduled arrival time. For example, an estimated time of arrival (ETA) of the vehicle 104 may be calculated as the time that the vehicle 104 will arrive at the scheduled destination if no additional anomalies occur that change the speed at which the vehicle 104 travels. If the ETA is the same as or within a predetermined time window of the scheduled arrival time, then the monitoring module 208 may calculate a large statistical measure of adherence for the vehicle 104. As the ETA differs from the scheduled arrival time (e.g., by occurring after the scheduled arrival time), the statistical measure of adherence may decrease.

Alternatively, the vehicle 104 (shown in FIG. 1) may adhere to the schedule by arriving at or passing through scheduled waypoints of the schedule at scheduled times that are associated with the waypoints, or within a predetermined time buffer of the scheduled times. As differences between actual times that the vehicle 104 arrives at or passes through the scheduled waypoints and the associated scheduled times of the waypoints increases, the statistical measure of adherence for the vehicle 104 may decrease. Conversely, as these differences decrease, the statistical measure of adherence may increase.

The monitoring module 208 may calculate the statistical measure of adherence as a time difference between the ETA of a vehicle 104 (shown in FIG. 1) and the scheduled arrival time of the schedule associated with the vehicle 104. Alternatively, the statistical measure of adherence for the vehicle 104 may be a fraction or percentage of the scheduled arrival time. For example, the statistical measure of adherence may be the fraction or percentage that the difference between the ETA and the scheduled arrival time is of the scheduled arrival time. In another example, the statistical measure of adherence may be a number of scheduled waypoints in a schedule of the vehicle 104 that the vehicle 104 arrives at or passes by later than the associated scheduled time or later than a time window after the scheduled time. Alternatively, the statistical measure of adherence may be a sum total, average, median, or other calculation of time differences between the actual times that the vehicle 104 arrives at or passes by scheduled waypoints and the associated scheduled times.

Table 1 below provides examples of statistical measures of adherence of a vehicle 104 (shown in FIG. 1) to an associated schedule in a movement plan. Table 1 includes four columns and seven rows. Table 1 represents at least a portion of a schedule of the vehicle 104. Several tables may be calculated for different schedules of different vehicles 104 in the movement plan for the transportation network 100 (shown in FIG. 1). The first column provides coordinates of scheduled locations that the vehicle 104 is to pass through or arrive at the corresponding scheduled times shown in the second column. The coordinates may be coordinates that are unique to a transportation network 100 or that are used for several transportation networks (e.g., Global Positioning System coordinates). The numbers used for the coordinates are provided merely as examples. Moreover, information regarding the scheduled location other than coordinates may be used.

TABLE 1

| Scheduled Location | | | |
|---|---|---|---|
| (SL) | Scheduled Time | Actual Time at SL | Difference |
| (123.4, 567.8) | 09:00 | 09:00 | 0 |
| (901.2, 345.6) | 09:30 | 09:33 | (0:03) |
| (789.0, 234.5) | 10:15 | 10:27 | (0:12) |
| (678.9, 345.6) | 10:43 | 10:44 | (0:01) |
| (987.6, 543.2) | 11:02 | 10:58 | 0:04 |
| (109.8, 765.4) | 11:15 | 11:14 | 0:01 |
| (321.0, 987.5) | 11:30 | 11:34 | (0:04) |

The third column includes a list of the actual times that the vehicle 104 (shown in FIG. 1) arrives at or passes through the associated scheduled location. For example, each row in Table 1 includes the actual time that the vehicle 104 arrives at or passes through the scheduled location listed in the first column for the corresponding row. The fourth column in Table 1 includes a list of differences between the scheduled times in the second column and the actual times in the third column for each scheduled location.

The differences between when the vehicle 104 (shown in FIG. 1) arrives at or passes through one or more scheduled locations and the time that the vehicle 104 was scheduled to arrive at or pass through the scheduled locations may be used to calculate the statistical measure of adherence to a schedule for the vehicle 104. In one embodiment, the statistical measure of adherence for the vehicle 104 may represent the number or percentage of scheduled locations that the vehicle 104 arrived too early or too late. For example, the monitoring module 208 may count the number of scheduled locations that the vehicle 104 arrives at or passes through outside of a time buffer around the scheduled time. The time buffer can be one to several minutes. By way of example only, if the time buffer is three minutes, then the monitoring module 208 may examine the differences between the scheduled times (in the second column of Table 1) and the actual times (in the third column of Table 1) and count the number of scheduled locations that the vehicle 104 arrived more than three minutes early or more than three minutes late.

Alternatively, the monitoring module 208 may count the number of scheduled locations that the vehicle 104 (shown in FIG. 1) arrived early or late without regard to a time buffer. With respect to Table 1, the vehicle 104 arrived at four of the scheduled locations within the time buffer of the scheduled times, arrived too late at two of the scheduled locations, and arrived too early at one of the scheduled locations.

The monitoring module 208 may calculate the statistical measure of adherence by the vehicle 104 (shown in FIG. 1) to the schedule based on the number or percentage of scheduled locations that the vehicle 104 arrived on time (or within the time buffer). In the illustrated embodiment, the monitoring module 208 can calculate that the vehicle 104 adhered to the schedule (e.g., remained on schedule) for 57% of the scheduled locations and that the vehicle 104 did not adhere (e.g., fell behind or ahead of the schedule) for 43% of the scheduled locations.

Alternatively, the monitoring module 208 may calculate the statistical measure of adherence by the vehicle 104 (shown in FIG. 1) to the schedule based on the total or sum of time differences between the scheduled times associated with the scheduled locations and the actual times that the vehicle 104 arrived at or passed through the scheduled locations. With respect to the example shown in Table 1, the monitoring module 208 may sum the time differences shown in the fourth column as the statistical measure of adherence. In the example of Table 1, the statistical measure of adherence is −15 minutes, or a total of 15 minutes behind the schedule of the vehicle 104.

In another embodiment, the monitoring module 208 may calculate the average statistical measure of adherence by comparing the deviation of each vehicle 104 (shown in FIG. 1) from the average or median statistical measure of adherence of the several vehicles 104 traveling in the transportation network 100 (shown in FIG. 1). For example, the monitoring module 208 may calculate an average or median deviation of the measure of adherence for the vehicles 104 from the average or median statistical measure of adherence of the vehicles 104.

The monitoring module 208 may determine the throughput parameters for the transportation network 100 (shown in FIG. 1), or an area thereof, based on the statistical measures of adherence associated with the vehicles 104 (shown in FIG. 1). For example, a throughput parameter may be an average, median, or other statistical calculation of the statistical measures of adherence for the vehicles 104 concurrently traveling in the transportation network 100. The throughput parameter may be calculated based on the statistical measures of adherence for all, substantially all, a supermajority, or a majority of the vehicles 104 traveling in the transportation network 100.

The scheduling module 206 creates schedules for the vehicles 104 (shown in FIG. 1) and transmits the schedules to the control systems 114 of the vehicles 104. In one embodiment, the scheduling module 206 may modify a previously created schedule that previously was sent to a vehicle 104. The scheduling module 206 may convey the schedules to the antenna 112, which transmits the schedules to the antennas 116 of the control systems 114 of the corresponding vehicles 104.

The control systems 114 of the vehicles 104 (shown in FIG. 1) receive the schedules sent by the scheduling system 110. In the illustrated embodiment, the control system 114 of a vehicle 104 includes a controller 210, such as a computer processor or other logic-based device that performs operations based on one or more sets of instructions (e.g., software). The instructions on which the controller 210 operates may be stored on a tangible and non-transitory (e.g., not a transient signal) computer readable storage medium, such as a memory 212. The memory 212 may include one or more computer hard drives, flash drives, RAM, ROM, EEPROM, and the like. Alternatively, one or more of the sets of instructions that direct operations of the controller 210 may be hard-wired into the logic of the controller 210, such as by being hard-wired logic formed in the hardware of the controller 210.

The control system 114 includes several modules that perform various operations described herein. The modules are shown as being included in the controller 210. As described above, the modules may include hardware and/or software systems that operate to perform one or more functions, such as the controller 210 and one or more sets of instructions. Alternatively, one or more of the modules may include a controller that is separate from the controller 210.

The control system 114 receives the schedules from the scheduling system 110. The controller 210 may be operatively coupled with the antenna 116 to receive the initial and/or modified schedules from the scheduling system 110. In one embodiment, the schedules are conveyed to an energy management module 214 of the control system 114. In another embodiment, the energy management module 214 may be disposed off-board the vehicle 104 (shown in FIG. 1) for which the trip plan is formed. For example, the energy management module 214 can be disposed in a central dispatch or other office that generates the trip plans for one or more vehicles 104.

The energy management module 214 receives the schedule sent from the scheduling system 110 and generates a trip plan based on the schedule. As described above, the trip plan may include throttle settings, brake settings, designated speeds, or the like, of the vehicle 104 (shown in FIG. 1) for various sections of a scheduled trip of the vehicle 104 to the scheduled destination location. The trip plan may be generated to reduce the amount of fuel that is consumed by the vehicle 104 as the vehicle 104 travels to the destination location relative to travel by the vehicle 104 to the destination location when not abiding by the trip plan.

In order to generate the trip plan for the vehicle 104 (shown in FIG. 1), the energy management module 214 can refer to a trip profile that includes information related to the vehicle 104, information related to the route 102 (shown in FIG. 1) over which the vehicle 104 travels to arrive at the scheduled destination, and/or other information related to travel of the vehicle 104 to the scheduled destination location at the scheduled arrival time. The information related to the vehicle 104 may include information regarding the fuel efficiency of the vehicle 104 (e.g., how much fuel is consumed by the vehicle 104 to traverse different sections of a route 102), the tractive power (e.g., horsepower) of the vehicle 104, the weight or mass of the vehicle 104 and/or cargo, the length and/or other size of the vehicle 104, the location of the powered units 106 (shown in FIG. 1) in the vehicle 104 (e.g., front, middle, back, or the like of a vehicle consist having several mechanically interconnected units 106, 108), or other information. The information related to the route 102 to be traversed by the vehicle 104 can include the shape (e.g., curvature), incline, decline, and the like, of various sections of the route 102, the existence and/or location of known slow orders or damaged sections of the route 102, and the like. Other information can include information that impacts the fuel efficiency of the vehicle 104, such as atmospheric pressure, temperature, and the like.

The trip plan is formulated by the energy management module 214 based on the trip profile. For example, if the trip profile requires the vehicle 104 (shown in FIG. 1) to traverse a steep incline and the trip profile indicates that the vehicle 104 is carrying significantly heavy cargo, then the energy management module 214 may form a trip plan that includes or dictates increased tractive efforts to be provided by the propulsion subsystem 118 of the vehicle 104. Conversely, if the vehicle 104 is carrying a smaller cargo load and/or is to travel down a decline in the route 102 (shown in FIG. 1) based on the trip profile, then the energy management module 214 may form a trip plan that includes or dictates decreased tractive efforts by the propulsion subsystem 118 for that segment of the trip. In one embodiment, the energy management module 214 includes a software application or system such as the Trip Optimizer™ system provided by General Electric Company.

The control system 114 includes a control module 218 that generates control signals for controlling operations of the vehicle 104 (shown in FIG. 1). The control module 218 may receive the trip plan from the energy management module 214 and generate the control signals that automatically change the tractive efforts and/or braking efforts of the propulsion subsystem 118 based on the trip plan. For example, the control module 218 may form the control signals to automatically match the speeds of the vehicle 104 with the speeds dictated by the trip plan for various sections of the trip of the vehicle 104 to the scheduled destination location. Alternatively, the control module 218 may form control signals that are conveyed to an output device 216 disposed on-board the vehicle 104. The output device 216 can visually and/or audibly present instructions to an operator of the vehicle 104 to change the tractive efforts and/or braking efforts of the vehicle 104 based on the control signals. For example, the output device 216 can visually present textual instructions to the operator to increase or decrease the speed of the vehicle 104 to match a designated speed of the trip plan.

As described above, the scheduling module 206 can coordinate the schedules of the vehicles 104 (shown in FIG. 1) to maintain the throughput parameter of the transportation network 100 (shown in FIG. 1) above a threshold. The scheduling module 206 can create and/or modify schedules of the vehicles 104 to maintain such a threshold parameter while also basing the schedules on the financial costs of fuel. By basing the schedules on fuel costs while coordinating the schedules to maintain a sufficiently high throughput parameter, the cost expended on fuel by the vehicles 104 may decrease without causing a significant negative impact on the flow of traffic in the transportation network 100.

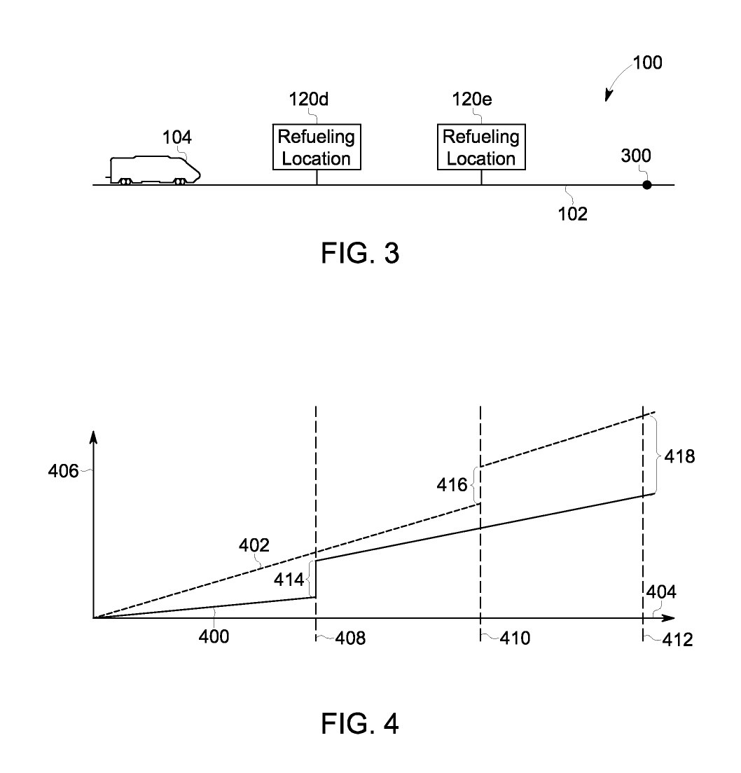

The scheduling module 206 may base the schedules of the vehicles 104 (shown in FIG. 1) in a variety of ways. FIGS. 3 through 7 provide some examples of the different ways in which schedules of the vehicles 104 may be created and/or modified based on financial costs of fuel. Additional examples of basing schedules on the financial costs of fuel may be used in conjunction with one or more embodiments of the inventive subject matter described and claimed herein. The examples shown and described in connection with FIGS. 3 through 7 are not intended to encompass all embodiments of the presently described inventive subject matter.

In one embodiment, previously generated schedules that are based on fuel costs for the vehicles 104 are modified based on the trip plans of the vehicles 104. For example, the scheduling system 110 can generate schedules for the vehicles 104 that are based on fuel costs. The vehicles 104 can then create trip plans based on the schedules and communicate the trip plans back to the scheduling system 110. The scheduling system 110 can then modify the schedules based on the fuel costs and the trip plans. The scheduling system 110 may modify the schedules because the trip plans created by one or more of the vehicles 104 may allow for a vehicle 104 to refuel at a less expensive location, wait for refueling, avoid the need for refueling, and the like. The schedules can be modified accordingly, as described herein.

In another embodiment, the energy management module 214 on the vehicle 104 can include the financial costs of fuel at various locations when generating the trip plan. For example, the energy management module 214 may form the trip plan based on how much fuel the vehicle 104 may require at various locations, where the vehicle 104 may need to refuel, and/or the costs of refueling at various locations. The energy management module 214 may emphasize or de-emphasize the fuel costs when generating the trip plan. For example, the energy management module 214 may assign a higher priority to reducing fuel consumed and/or emissions generated when forming a trip plan relative to the fuel costs. As a result, the energy management module 214 may end up creating a trip plan that may cause the vehicle 104 to refuel at a more expensive location, but that also causes the vehicle 104 to consume less fuel and/or generate fewer emissions. Alternatively, the energy management module 214 may assign a lower priority to reducing fuel consumed and/or emissions generated when forming a trip plan relative to the fuel costs. As a result, the energy management module 214 may end up creating a trip plan that may cause the vehicle 104 to refuel at a less expensive location, but that also causes the vehicle 104 to consume more fuel and/or generate more emissions.

FIG. 3 is a schematic diagram of a portion of the transportation network 100 in accordance with one embodiment. The illustrated portion includes a vehicle 104 traveling along a route 102 of the transportation network 100 toward a plurality of refueling locations 120d, 120e. The first refueling location 120d is closer to the vehicle 104 along the direction of travel of the vehicle 104 such that the vehicle 104 will arrive at the first refueling location 120d before the second refueling location 120e. The vehicle 104 may be carrying sufficient fuel to reach the first refueling location 120d if the vehicle 104 runs, or travels, at a first speed. But, the vehicle 104 may have insufficient fuel to reach the second refueling location 120e if the vehicle 104 runs at the first speed without stopping to at least partially refuel at the first refueling location 120d. The first speed may be a speed limit of the route 102, such as the track speed of a railroad track. If the vehicle 104 travels at a slower, second speed, the vehicle 104 has sufficient fuel to bypass the first refueling location 120d and to reach the second refueling location 120e before refueling. The refueling locations 120d, 120e may sell fuel to the vehicle 104 at different prices. For example, the closer first refueling location 120d may sell the fuel at a lower cost per unit volume than the farther second refueling location 120e.

The monitoring module 208 (shown in FIG. 2) of the scheduling system 110 (shown in FIG. 1) may track the prices at which fuel is sold at the refueling locations 120. For example, the monitoring module 208 may periodically query a remotely hosted database, server, or other memory storage location for current or anticipated fuel prices at the refueling locations 120. Alternatively, the fuel prices of the refueling locations 120 may be transmitted to or input into the scheduling system 110 by an operator.

The scheduling module 206 (shown in FIG. 2) of the scheduling system 110 (shown in FIG. 1) may use the fuel prices tracked by the monitoring module 208 (shown in FIG. 2) to create and/or modify a schedule for the vehicle 104. For example, the scheduling module 206 may determine if the schedule of the vehicle 104 can be created and/or modified such that the vehicle 104 can bypass the closer, but more expensive, first refueling location 120d and proceed to the farther, but less expensive, second refueling location 120e before refueling.

With continued reference to FIG. 3, FIG. 4 illustrates examples of velocity curves 400, 402 for the vehicle 104 traveling in the portion of the transportation network 100 shown in FIG. 3. The velocity curves 400, 402 are shown alongside a horizontal axis 404 representative of distance and a vertical axis 406 representative of time. The intersection of the horizontal and vertical axes 404, 406 represent a location of the vehicle 104. A first distance marker 408 represents the location of the first refueling location 120d from the vehicle 104 and a second distance marker 410 represents the location of the second refueling location 120e from the vehicle 104.

The velocity curves 400, 402 can represent potential schedules of the vehicle 104 as created and/or modified by the scheduling module 206 (shown in FIG. 2) of the scheduling system 110 (shown in FIG. 1). For example, the velocity curve 400 can represent the locations of the vehicle 104 at different times as the vehicle 104 moves along the route 102 to a destination location 300 when the vehicle 104 travels according to a first schedule and the velocity curve 402 can represent the locations of the vehicle 104 at different times when the vehicle 104 travels to the destination location 300 according to a different, second schedule. The location of the destination location 300 is represented in FIG. 4 by a distance marker 412.

The scheduling module 206 can delay or push back the scheduled arrival time of the vehicle 104 in order to permit the vehicle 104 to avoid having to stop and refuel at a more expensive refueling location 120d in favor of refueling at another, less expensive refueling location 120e. The velocity curve 400 of the first schedule causes the vehicle 104 to travel at a faster speed than the velocity curve 402 of the second schedule to the first refueling location 120d. The vehicle 104 may be carrying insufficient fuel to reach the second refueling location 120e without refueling at the first refueling location 120d when traveling according to the velocity curve 400. As a result, the vehicle 104 stops for a time period 414 to refuel at the first refueling location 120d before proceeding on the route 102 to the destination location 300.

The velocity curve 402 of the second schedule causes the vehicle 104 to travel at a slower speed than the velocity curve 400 of the first schedule. The vehicle 104 may be carrying sufficient fuel to reach the second refueling location 120e without refueling at the first refueling location 120d when traveling according to the velocity curve 402. The vehicle 104 stops to refuel at the second refueling location 120e for a time period 416 before proceeding to the destination location 300. As a result, the vehicle 104 can bypass the first refueling location 120d and proceed to the second refueling location 120e before stopping to refuel. Alternatively, the slower speed of the second schedule may allow the vehicle 104 to proceed to the destination location 300 without stopping to refuel at either of the refueling locations 120d, 120e.

Both velocity curves 400, 402 and the first and second schedules may include the vehicle 104 starting in the same location and traveling to the same destination location 300. If the second refueling location 120e sells fuel at a lower cost, then traveling along the route 102 according to the second schedule (e.g., the velocity curve 402) may result in reduced fuel costs for a trip by the vehicle 104 to the destination location relative to traveling according to the first schedule (e.g., the velocity curve 400). As shown in FIG. 4, traveling at the slower speeds of the second schedule (e.g., using the second velocity curve 402) may result in the vehicle 104 arriving at the destination location 300 at a later time than the vehicle 104 would have arrived if the vehicle 104 traveled according to the first schedule (e.g., using the first velocity curve 400). The time difference between arrivals at the destination location 300 when using the first or second schedules is represented by a time delay 418 in FIG. 4.

In another example, the scheduling module 206 (shown in FIG. 2) can create and/or modify a schedule of a vehicle 104 such that the vehicle 104 does not slow down or stop during a trip toward a destination location, where such slowing down or stopping would require the vehicle 104 to refuel at a first refueling location 120 having more expensive fuel than a second refueling location 120. The first refueling location 120 may be closer to a current location or a starting location of the vehicle 104, but due to the amount of fuel carried by the vehicle 104 and/or the fuel efficiency of the vehicle 104, stopping or slowing down (e.g., pulling off a main line track onto a siding section of track for a meet event or a pass event between trains) may cause the vehicle 104 to need to stop and refuel at the closer, but more expensive first refueling location 120. Refraining from slowing down and/or stopping may allow the vehicle 104 to pass the more expensive first refueling location 120 and reach the less expensive second refueling location 120.

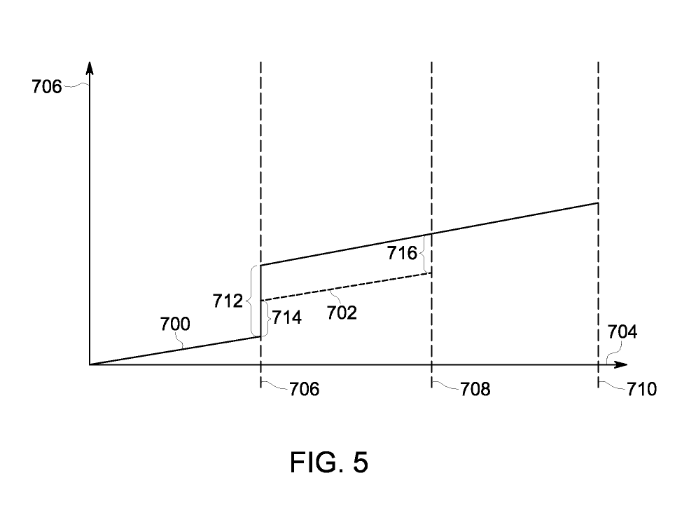

With continued reference to FIG. 3, FIG. 5 illustrates examples of other velocity curves 700, 702 for the vehicle 104 traveling in the portion of the transportation network 100 shown in FIG. 3. The velocity curves 700, 702 are shown alongside a horizontal axis 704 representative of distance and a vertical axis 706 representative of time. A first distance marker 706 represents the location of the first refueling location 120d, a second distance marker 708 represents the location of the second refueling location 120e, and a third distance marker 710 represents the location of the destination location 300.

The velocity curves 700, 702 can represent potential schedules of the vehicle 104 as created and/or modified by the scheduling module 206 (shown in FIG. 2) of the scheduling system 110 (shown in FIG. 1). The vehicle 104 may have insufficient fuel to reach the destination location 300 without stopping to refuel at one or more of the refueling locations 120d, 120e. In a first schedule that corresponds to the velocity curve 700, the scheduling module 206 may schedule the vehicle 104 to proceed to the first refueling location 120d and refuel for a time period 712 before proceeding on to the destination location 300. In a second schedule that corresponds to the velocity curve 702, the scheduling module 206 may schedule the vehicle 104 to travel to the first refueling location 120d and refuel for a time period 714 that is shorter than the time period 712 of the first schedule. The second schedule may then direct the vehicle 104 to proceed to the second refueling location 120e and obtain additional fuel over a time period 716 before proceeding to the destination location 300.

As shown in FIG. 5, the first and second schedules (as represented by the velocity curves 700, 702), may be identical or similar until the vehicle 104 arrives at the first refueling location 120d. The first schedule then causes the vehicle 104 to obtain more fuel at the first refueling location 120d over a longer time period 712 than the second schedule. For example, the first schedule may cause the vehicle 104 to fully refuel or obtain at least a predetermined or predesignated threshold amount of fuel at the first refueling location 120d. On the other hand, the second schedule may cause the vehicle 104 to obtain a smaller amount of fuel, such as enough fuel to reach the second refueling location 120e, at the first refueling location 120d. Obtaining a smaller amount of fuel can result in the vehicle 104 being stopped at the first refueling location 120d for the shorter time period 714 relative to the time period 712 of the first schedule.

In the illustrated embodiment, the velocity curves 700, 702 overlap or are coextensive with each other from the intersection of the horizontal and vertical axes 704, 706 to the first distance marker 706 and from the second distance marker 708 to the third distance marker 710. For example, the first and second schedules may dictate that the vehicle 104 travel at the same speeds up to the first refueling location 120d and from the second refueling location 120e to the destination location 300. Alternatively, the velocity curves 700, 702 may not overlap or be coextensive with each other before the first distance marker 706 and/or after the second distance marker 708. For example, the first and second schedules may dictate that the vehicle 104 travels at different speeds up to the first refueling location 120d and/or from the second refueling location 120e to the destination location 300.

The scheduling module 206 (shown in FIG. 2) may create and/or modify the schedule of the vehicle 104 to the second schedule if the second refueling location 120e sells fuel at a lower cost than the first refueling location 120d. As a result, traveling along the route 102 according to the second schedule (e.g., the velocity curve 702) may result in reduced fuel costs for a trip by the vehicle 104 to the destination location 300 relative to traveling according to the first schedule (e.g., the velocity curve 700).

In another example, the scheduling module 206 can create and/or modify a schedule of the vehicle 104 such that the vehicle 104 only partially refuels at a refueling location 120 so that the vehicle 104 can continue traveling at an earlier time than if the vehicle 104 fully refueled. The scheduling module 206 may schedule a first vehicle 104 to only partially refuel in order to get the first vehicle 104 moving in the transportation network 100 sooner so that a second vehicle 104 can refuel at the same refueling location 120, so that the first vehicle 104 can move on to get out of the way of a second vehicle 104 traveling in the transportation network 100, so that the first vehicle 104 can proceed to arrive to an event with a second vehicle 104 (e.g., a meet event or a pass event between trains) in time, or the like. Avoiding a schedule that causes the first vehicle 104 to fully refuel can prevent increased congestion or a decreased throughput parameter of the transportation network 100.

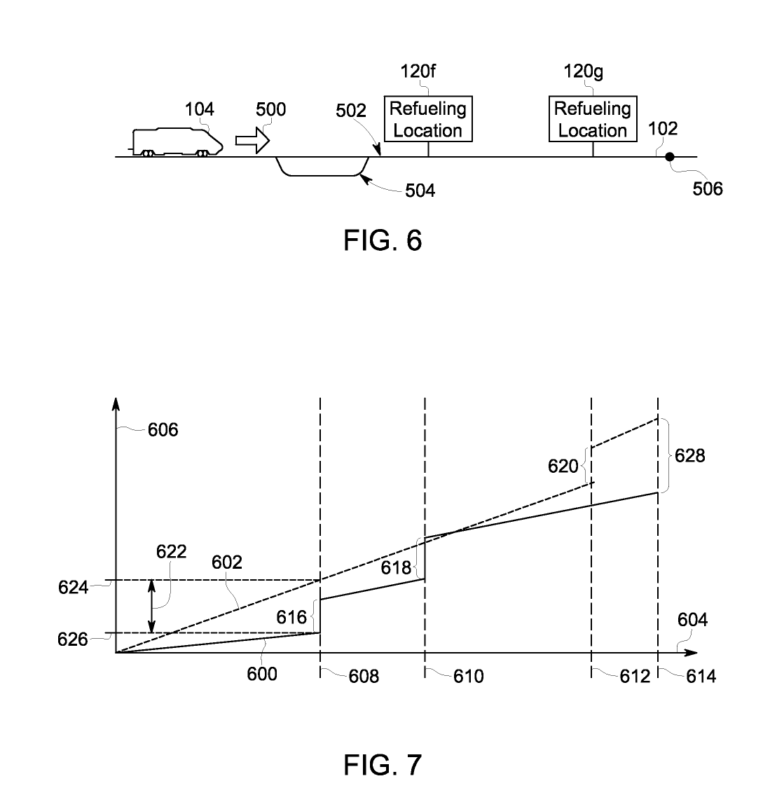

FIG. 6 is a schematic diagram of another portion of the transportation network 100 in accordance with one embodiment. The illustrated portion includes a vehicle 104 traveling along a route 102 of the transportation network 100 toward a plurality of refueling locations 120f, 120g. The first refueling location 120f is closer to the vehicle 104 along a direction of travel of the vehicle 104 (indicated by arrow 500) such that the vehicle 104 will arrive at the first refueling location 120f before the second refueling location 120g. The route 102 includes a main line section 502 and a siding section 504. The main line section 502 may be a single track or path such that two vehicles 104 cannot concurrently travel over the same point of the main line section 502 at a time. For example, the main line section 502 may represent a single railroad track that can allow several vehicles 104 to travel in the same direction at the same time, but cannot allow one vehicle 104 to pass another vehicle 104 or to allow two vehicles 104 to pass each other in opposite directions on the main line section 502.

The siding section 504 is a portion of the route 102 that is coupled with the main line section 502 and provides a path for a vehicle 104 to pull off of the main line section 502. For example, if two vehicles 104 are traveling in opposite directions on the main line section 502, one of the vehicles 104 can pull off of the main line section 502 and onto the siding section 504 while the other vehicle 104 passes on the main line section 502. The vehicle 104 on the siding section 504 may then return to, and proceed along, the main line section 502. Similarly, when two vehicles 104 are traveling in the same direction along the main line section 502, a slower moving vehicle 104 can pull off onto the siding section 504 to allow a faster moving vehicle 104 to pass on the main line section 502. The slower moving vehicle 104 can then return to, and proceed along, the main line section 502 behind the faster moving vehicle 104.

In the example shown in FIG. 6, at least two potential schedules may be used for the vehicle 104. With respect to a first schedule, the vehicle 104 may proceed on the main line section 502 along the direction of the arrow 500 to the siding section 504. The vehicle 104 can then slow down to pull off of the main line section 502 and onto the siding section 504. The vehicle 104 may proceed slowly or stop on the siding section 504 to allow another vehicle 104 to pass on the main line section 502, either in the direction of the arrow 500 or in an opposite direction. Once the other vehicle 104 passes, the vehicle 104 on the siding section 504 can return to, and proceed along, the main line section 502. The vehicle 104 then proceeds to a destination location 506.

The vehicle 104 may consume enough fuel when the vehicle 104 pulls off onto the siding section 504, slows down and/or stops, and then accelerates back onto the main line section 502 that the vehicle 104 needs to stop at the first refueling location 120f. For example, the vehicle 104 may have insufficient fuel to pull off onto the siding section 504, slow down and/or stop, and then accelerate to the main line section 502 to reach the destination location 506 without stopping for fuel at the refueling location 120f. The amount of fuel carried by the vehicle 104 when the vehicle 104 reaches the first refueling location 120f and after pulling onto and returning from the siding section 504 may be insufficient for the vehicle 104 to reach the second refueling location 120g. As a result, the vehicle 104 stops at the first refueling location 120f to at least partially refuel.

With respect to a second schedule for the vehicle 104, the vehicle 104 may proceed on the main line section 502 along the direction of the arrow 500 to the siding section 504. The vehicle 104 may proceed to the siding section 504 at a slower speed than the speed that the vehicle 104 would travel to the siding section 504 according to the first schedule. For example, the first schedule may dictate that the vehicle 104 proceed to the siding section 504 at track speed, or a speed limit of the route 102, while the second schedule may dictate that the vehicle 104 proceed at a slower speed.

Due to the slower speed of the vehicle 104, the vehicle 104 may not pull off onto the siding section 504. The vehicle 104 may arrive at the siding section 504 sufficiently late that other vehicles 104 on the main line section 502 already have passed the siding section 504. For example, the vehicle 104 (e.g., “first vehicle”) may proceed to the siding section 504 slowly enough that another vehicle 104 (e.g., “second vehicle”) traveling toward the first vehicle 104 may pass the siding section 504 and pull off of the main line section 502 and onto another route 102 in the transportation network 100 before the first vehicle 104 encounters the second vehicle 104.

The vehicle 104 may consume a lesser amount of fuel traveling according to the slower second schedule than traveling according to the faster first schedule. For example, by traveling on the main line section 502 at a slower speed and/or by not pulling off onto the siding section 504, slowing down and/or stopping, and then accelerating back onto the main line section 502, the vehicle 104 may burn less fuel when traveling to the destination location 506 according to the second schedule than when traveling to the destination location 506 according to the first schedule.

The amount of fuel carried by the vehicle 104 may be enough that, when the vehicle 104 travels according to the second schedule, the vehicle 104 does not need to stop and refuel at the first refueling location 120f to reach the destination location 506, but can continue on to the second refueling location 120g before at least partially refueling.

With continued reference to FIG. 6, FIG. 7 illustrates examples of velocity curves 600, 602 for the vehicle 104 traveling in the portion of the transportation network 100 shown in FIG. 6. The velocity curves 600, 602 are shown alongside a horizontal axis 604 representative of distance and a vertical axis 606 representative of time. A first distance marker 608 represents the location of the siding section 504, a second distance marker 610 represents the location of the first refueling location 120f, a third distance marker 612 represents the location of the second refueling location 120g, and a fourth distance marker 614 represents the location of the destination location 506.

The velocity curves 600, 602 can represent the first and second schedules described above. The scheduling module 206 (shown in FIG. 2) can delay or push back the scheduled arrival time of the vehicle 104 at the destination location 506 in order to permit the vehicle 104 to avoid having to pull off onto the siding section 504 and stop and refuel at the first refueling location 120f. For example, the monitoring module 208 (shown in FIG. 2) may determine that the first refueling location 120f sells fuel at a higher cost than the second refueling location 120g. The scheduling module 206 may delay the scheduled arrival time of the vehicle 104 at the destination location 506 such that the vehicle 104 does not pull onto the siding section 504 and refuels at the second refueling location 120g instead of refueling at the first refueling location 120f.

The velocity curve 600 of the first schedule causes the vehicle 104 to travel at a faster speed than the velocity curve 602 of the second schedule to the siding section 504 (e.g., the first distance marker 608). The vehicle 104 slows down or stops for a time period 616 on the siding section 504 to allow another vehicle 104 to pass on the main line section 502. The vehicle 104 then pulls back onto the main line section 502 and proceeds to the first refueling location 120f (e.g., the second distance marker 610), where the vehicle 104 stops for a time period 618 to refuel. The vehicle 104 then proceeds to the destination location 506 (e.g., the fourth distance marker 614).

The velocity curve 602 of the second schedule causes the vehicle 104 to travel at a slower speed than the velocity curve 600 of the first schedule. The vehicle 104 may travel slowly enough that the vehicle 104 does not pull onto the siding section 504 (e.g., the first distance marker 608), as described above. The vehicle 104 instead proceeds along the main line section 502 at the slower speed. The vehicle 104 may be consuming less fuel relative to the velocity curve 600 that the vehicle 104 can pass the first refueling location 120f (e.g., the second distance marker 610) and reach the second refueling location 120g (e.g., the third distance marker 612) before needing to stop for fuel. The vehicle 104 stops at the second refueling location 120g for a time period 620 to refuel before proceeding to the destination location 506 (e.g., the fourth distance marker 614).

Both velocity curves 600, 602 and the first and second schedules may include the vehicle 104 starting in the same location and traveling to the same destination location 506. If the second refueling location 120g sells fuel at a lower cost, then traveling along the route 102 according to the second schedule (e.g., the velocity curve 602) may result in reduced fuel costs for a trip by the vehicle 104 to the destination location 506 relative to traveling according to the first schedule (e.g., the velocity curve 600). As shown in FIG. 7, traveling at the slower speeds of the second schedule (e.g., using the second velocity curve 602) may result in the vehicle 104 arriving at the siding section 504 (e.g., the first distance marker 608) at a time 624 that is later than a time 626 that the vehicle 104 would arrive at the siding section 504 had the vehicle 104 traveled according to the first schedule. A delay time difference 622 between the times 624 and 626 represents how much later the vehicle 104 arrives or passes the siding section 504 when traveling according to the second schedule relative to the first schedule. The delay time difference 622 may be sufficiently long that other vehicles pass the siding section 504 such that the vehicle 104 does not need to pull onto the siding section 504 to avoid collision with the other vehicles, as described above.

Traveling according to the second schedule may cause the vehicle 104 to arrive at the destination location 506 at a later time than the vehicle 104 would have arrived if the vehicle 104 traveled according to the first schedule. The time difference between arrivals at the destination location 506 when using the first or second schedules is represented by a time delay 628 in FIG. 7.

As another example of creating and/or modifying a schedule to reduce fuel costs, the scheduling module 206 (shown in FIG. 2) can schedule a vehicle 104 to at least partially refuel based on the types of fuels used by the vehicle 104, the locations of the refueling locations 120 that provide one or more of the different types of fuel, and/or the comparative costs of the different types of fuel. For example, a vehicle 104 may be a hybrid vehicle 104 that is capable of operating using two or more types of fuel, such as diesel fuel and natural gas. The cost of one type of fuel may be less than the cost of another type of fuel, but not all fuels may be available at all refueling locations 120. As a result, the scheduling module 206 may create the schedule of a hybrid vehicle 104 such that the vehicle 104 only partially refuels with a more expensive first type of fuel at a closer first refueling location 120 before proceeding to a farther second refueling location 120 that provides the less expensive second type of fuel that can be used by the vehicle 104.

Returning to the discussion of the scheduling system 110 shown in FIG. 2, and as described above, the scheduling module 206 can coordinate schedules of multiple vehicles 104 (shown in FIG. 1) concurrently traveling in the transportation network 100 (shown in FIG. 1) in order to maintain a throughput parameter of the transportation network 100 above a threshold while reducing fuel costs for operating the vehicles 104. The scheduling system 110 can create and/or modify schedules of the vehicles 104 so that one or more vehicles 104 at least partially refuel at a refueling location 120 that provides less expensive fuel than another refueling location 120 while avoiding significantly slowing the flow of traffic through the transportation network 100.

In one embodiment, the scheduling module 206 may generate several different sets of potential schedules for the vehicles 104 (shown in FIG. 1) and the monitoring module 208 may calculate throughput parameters associated with the different sets of the schedules. For example, the scheduling module 206 may create several sets of schedules for the vehicles 104 that are created to reduce the financial costs of fuel for one or more of the vehicles 104 and the monitoring module 208 may simulate travel of the vehicles 104 according to each of the sets of schedules. Based on the simulated travel, the monitoring module 208 may calculate a simulated throughput parameter for each set of schedules. The monitoring module 208 can compare the throughput parameters of the different sets and, based on the comparison, select one of the sets of schedules to send to the vehicles 104 for use in traveling in the transportation network 100 (shown in FIG. 1). For example, the scheduling module 206 may select the set of schedules having the largest throughput parameter, or a throughput parameter that is larger than one or more other throughput parameters associated with one or more other sets of schedules, and send the selected set of schedules to the vehicles 104.

Alternatively, the scheduling module 206 may generate a set of schedules and the monitoring module 208 can simulate travel of the vehicles 104 in the transportation network 100 according to the simulated travel. The monitoring module 208 can calculate a simulated throughput parameter for the set based on the travel of the vehicles 104 according to the set of schedules. If the simulated throughput parameter exceeds a predesignated threshold, such as a non-zero threshold, then the scheduling module 206 may select that set of schedules to send to the vehicles 104. If the simulated throughput parameter does not exceed the threshold, then the scheduling module 206 may generate another, different set of schedules and calculate another simulated throughput parameter. The scheduling module 206 may continue generating sets of schedules and simulating throughput parameters until a simulated throughput parameter of a set exceeds the threshold. If no simulated throughput parameter exceeds the threshold, then the scheduling module 206 may select the set of schedules having a simulated throughput parameter that is larger than the other simulated throughput parameters or the set having a simulated throughput parameter that is greater than the simulated throughput parameter of one or more other sets of schedules.

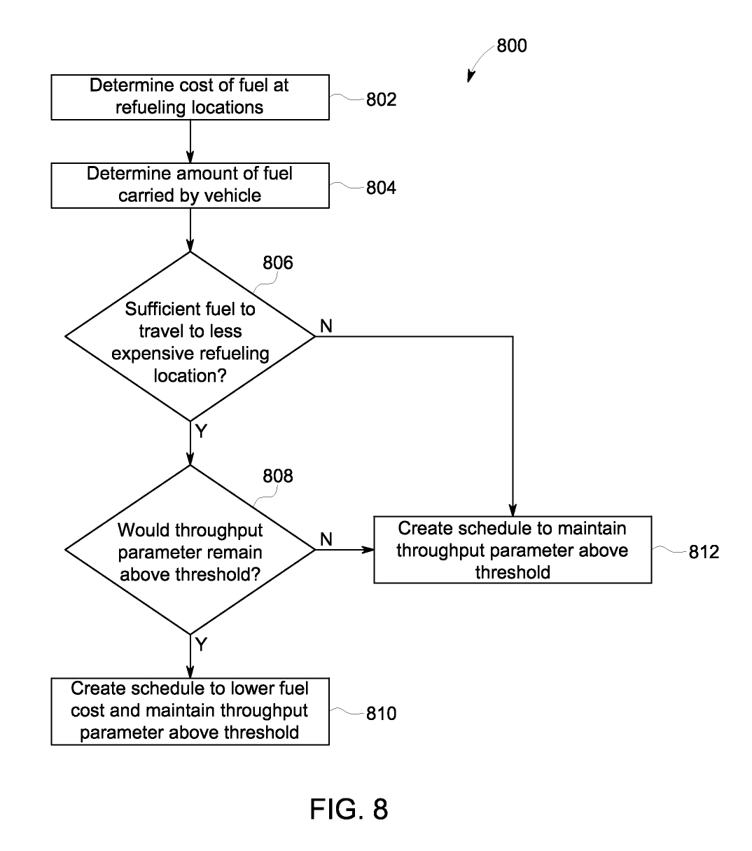

FIG. 8 is a flowchart of one embodiment of a method 800 for scheduling travel of vehicles in a transportation network based on fuel costs and throughput parameters of the transportation network. The method 800 may be used in conjunction with one or more embodiments of the scheduling system 100 (shown in FIG. 1) described above.

At 802, the financial costs of fuel at refueling locations 120 (shown in FIG. 1) are determined. The costs may be determined for several refueling locations 120 disposed along the path of the vehicle 104 (shown in FIG. 1) traveling through the transportation network 100 (shown in FIG. 1) to a destination location. The costs may be determined for a single type of fuel that is used by the vehicle 104 (e.g., the costs of diesel fuel for a locomotive that is propelled by electric current generated by a diesel engine) or for different types of fuel used by the vehicle 104 (e.g., the costs of diesel fuel and natural gas for a locomotive having a hybrid engine that operates on diesel fuel or natural gas).

At 804, the amount of fuel that is carried by the vehicle 104 (shown in FIG. 1) is determined. For example, the control module 218 (shown in FIG. 2) of the control system 114 (shown in FIG. 1) in the vehicle 104 may measure the amount of fuel carried in a fuel tank of the vehicle 104 from a sensor, such as a fuel gauge. The control system 114 may transmit the amount of fuel in the tank to the scheduling system 110, such as by wirelessly transmitting the amount of fuel from the antenna 116 of the vehicle 104 to the antenna 112 of the scheduling system 110.

At 806, a determination is made as to whether the vehicle 104 (shown in FIG. 1) has sufficient fuel to travel to a refueling location 120 (shown in FIG. 1) having less expensive fuel than one or more other refueling locations 120. For example, the fuel efficiency of the vehicle 104 at various speeds may be examined in light of distances to the different refueling locations 120 that provide the fuel used by the vehicle 104, the distances of the refueling locations 120 from the destination location of the vehicle 104, the distances of the refueling locations 120 from each other, and the costs of purchasing fuel at the different refueling locations 120. The fuel efficiency of the vehicle 104 (such as the rate at which the vehicle 104 consumes fuel) and the amount of fuel carried by the vehicle 104 can limit which refueling locations 120 that the vehicle 104 can travel to in order to obtain more fuel.

Additionally, the distances between refueling locations 120 can limit which refueling locations 120 may be used to refuel. For example, if the vehicle 104 can reach a more expensive refueling location 120 but not a less expensive refueling location 120, then the vehicle 104 may be scheduled to travel to the more expensive refueling location 120 to only partially refuel with enough fuel to travel to the less expensive refueling location 120, as described above.

If the vehicle 104 has sufficient fuel to reach a refueling location 120 that is less expensive than one or more other refueling locations 120, then the vehicle 104 may be able to travel to the less expensive refueling location 120 to obtain fuel instead of traveling to a more expensive refueling location 120 for fuel. As a result, flow of the method 800 proceeds to 808. On the other hand, if the vehicle 104 is not able to travel to a less expensive refueling location 120, then the vehicle 104 may proceed along the path to the destination location and refuel, if necessary, at one or more other refueling locations 120. As a result, flow of the method 800 proceeds to 812.

At 808, a throughput parameter for the transportation network 100 (shown in FIG. 1) and/or for one or more areas of the transportation network 100 is determined for a schedule that includes the vehicle 104 (shown in FIG. 1) traveling to the less expensive refueling location 120 (shown in FIG. 1) to at least partially refuel. For example, a simulated throughput parameter may be calculated for a simulation of the vehicle 104 traveling to the less expensive refueling location 120 to refuel instead of proceeding to and refueling at the more expensive refueling location 120. As described above, traveling to the less expensive refueling location 120 can involve the vehicle 104 traveling at a slower speed. The slower speed of the vehicle 104 may negatively impact the flow of other vehicles 104 concurrently traveling in the transportation network 100 as other vehicles 104 may have to wait on the vehicle 104 to pass a siding section 504, converge onto the same route 102 as the other vehicles 104, or otherwise interact with the vehicle 104.

The throughput parameter is calculated for a schedule that involves the vehicle 104 traveling to the less expensive refueling location 120 to avoid significantly increasing traffic congestion in the transportation network 100. If the throughput parameter would not decrease below a predetermined threshold, such as a non-zero threshold, then scheduling the vehicle 104 to refuel at the less expensive refueling location 120 may not have a significantly negative impact on the flow of traffic in the transportation network 100. As a result, flow of the method 800 proceeds to 810. On the other hand, if the throughput parameter would decrease below a predetermined threshold, then scheduling the vehicle 104 to refuel at the less expensive refueling location 120 may have a significantly negative impact on the flow of traffic in the transportation network 100. As a result, flow of the method 800 proceeds to 812.

At 810, a schedule is created that includes the vehicle 104 refueling at the less expensive refueling location. The schedule permits the vehicle 104 to save costs by refueling at a less expensive refueling location, but also keeps the throughput parameter of the transportation network 100 above the threshold. The schedule may be communicated to the vehicle 104 and the vehicle 104 may travel to the destination location according to the schedule.

At 812, a schedule is created that does not include the vehicle 104 refueling at the less expensive refueling location. For example, if the vehicle 104 does not have sufficient fuel to reach the refueling location, the vehicle 104 is not fuel efficient enough to reach the refueling location, and/or the flow of travel of other vehicles 104 in the transportation network 100 would be too adversely affected by the vehicle 104 refueling at the less expensive refueling location 120 (e.g., the throughput parameter would decrease below the threshold), then a schedule may be created that includes the vehicle 104 refueling at a more expensive refueling location 120. The schedule may be coordinated with the schedules of other vehicles 104 in the transportation network 100 so that the throughput parameter of the transportation network 100 remains above the threshold.

In one embodiment, a system includes a scheduling module and a monitoring module. The scheduling module is configured to generate schedules for vehicles to concurrently travel in a transportation network formed of interconnected routes over which the vehicles travel. The monitoring module is configured to determine financial costs of fuel at refueling locations within the transportation network that are used by one or more of the vehicles to acquire additional fuel. The scheduling module is configured to coordinate the schedules of the vehicles based on the financial costs of the fuel while maintaining a throughput parameter of the transportation network above a designated threshold. The throughput parameter representative of adherence by the vehicles to the schedules as the vehicles travel through the transportation network.

In another aspect, the threshold is a predetermined, nonzero threshold. In another aspect, the scheduling module is configured to generate the schedules such that amounts of the fuel consumed by the vehicles as the vehicles travel in the transportation network while maintaining the throughput parameter above the threshold are less than if the vehicles traveled through the transportation network according to other schedules.

In another aspect, the monitoring module is configured to determine different types of the fuel available for refueling at the refueling locations and the scheduling module is configured to generate the schedules based on the different types of the fuel at the refueling locations and the types of the fuel consumed by the vehicles.

In another aspect, the scheduling module is configured to generate the schedules based on relative differences between the refueling locations and the financial costs of the fuel at the refueling locations in the transportation network.

In another aspect, the monitoring module is configured to track amounts of the fuel carried by the vehicles as the vehicles travel in the transportation network. The scheduling module is configured to generate the schedules based on the amounts of fuel carried by the vehicles, distances between locations of the vehicles and the refueling locations, and the financial costs of the fuel at the refueling locations.

In another aspect, the scheduling module is configured to generate at least one of the schedules such that one or more of the vehicles travels to a first refueling location of the refueling locations to obtain an amount of fuel that is less than is necessary to fully refuel and such that the one or more of the vehicles travels to a second refueling location of the refueling locations to fully refuel based on a comparison of the financial costs of the fuel at the first refueling location and the second refueling location.

In another aspect, the scheduling module is configured to generate at least one of the schedules such that one or more of the vehicles fully refuels at a first refueling location of the refueling locations before an amount of fuel carried by the one or more vehicles falls below a refueling threshold based on a comparison between the financial costs of the fuel at the first refueling location and a different, second refueling location of the refueling locations.

In another aspect, the scheduling module is configured to generate at least one of the schedules such that one or more of the vehicles fully refuels at one or more of the refueling locations before an amount of fuel carried by the one or more vehicles falls below a refueling threshold when the one or more of the vehicles can refuel without reducing the throughput parameter of the transportation network to or below the threshold.

In another aspect, the scheduling module is configured to delay a previously scheduled arrival time for one or more of the vehicles to arrive at a scheduled destination location when the one or more of the vehicles is traveling from a first area of the transportation network to a different, second area of the transportation network that is associated with lower financial costs of fuel relative to the first area.

In another aspect, the scheduling module is configured to generate at least one of the schedules for one or more of the vehicles that are capable of self-propulsion using a plurality of different fuels such that the one or more of the vehicles change which of the different fuels is used to propel the one or more of the vehicles based on relative financial costs of refueling the different fuels in one or more areas of the transportation network.

In another aspect, the scheduling module is configured to generate the schedules for a plurality of rail vehicles traveling in the transportation network formed from interconnected tracks.

In another embodiment, a method includes determining financial costs of fuel at refueling locations within a transportation network formed of interconnected routes over which vehicles travel and generating schedules for the vehicles to concurrently travel in the transportation network. One or more of the schedules includes a refueling stop for one or more of the vehicles at one or more of the refueling locations. The schedules are generated by coordinating the schedules with each other based on financial costs of the fuel at the refueling locations while maintaining a throughput parameter of the transportation network above a non-zero threshold, the throughput parameter representative of adherence by the vehicles to the schedules as the vehicles travel through the transportation network.

In another aspect, generating the schedules includes establishing destination locations and associated times for the vehicles in the transportation network such that amounts of the fuel consumed by the vehicles as the vehicles travel in the transportation network are less than if the vehicles traveled through the transportation network according to other schedules while maintaining the throughput parameter above the threshold.

In another aspect, the method also includes determining different types of the fuel available for refueling at the refueling locations. Generating the schedules may include creating the schedules based on the different types of the fuel at the refueling locations and the types of the fuel consumed by the vehicles.

In another aspect, generating the schedules includes creating the schedules based on relative differences between the refueling locations and the financial costs of the fuel at the refueling locations in the transportation network.

In another aspect, the method also includes tracking amounts of the fuel carried by the vehicles as the vehicles travel in the transportation network. Generating the schedules includes creating the schedules based on the amounts of fuel carried by the vehicles, distances between locations of the vehicles and the refueling locations, and the financial costs of the fuel at the refueling locations.

In another aspect, generating the schedules includes creating at least one of the schedules such that one or more of the vehicles travels to a first refueling location of the refueling locations to obtain an amount of fuel that is less than is necessary to fully refuel and such that the one or more of the vehicles travels to a second refueling location of the refueling locations to fully refuel based on a comparison of the financial costs of the fuel at the first refueling location and the second refueling location.

In another aspect, generating the schedules includes creating at least one of the schedules such that one or more of the vehicles fully refuels at a first refueling location of the refueling locations before an amount of fuel carried by the one or more vehicles falls below a refueling threshold based on a comparison between the financial costs of the fuel at the first refueling location and a different, second refueling location of the refueling locations.

In another aspect, generating the schedules includes creating at least one of the schedules such that one or more of the vehicles fully refuels at one or more of the refueling locations before an amount of fuel carried by the one or more vehicles falls below a refueling threshold when the one or more of the vehicles can refuel without reducing the throughput parameter of the transportation network to or below the threshold.

In another aspect, generating the schedules includes moving a scheduled destination time for one or more of the vehicles to a later time when the one or more of the vehicles is traveling from a first area of the transportation network to a different, second area of the transportation network that is associated with lower financial costs of fuel relative to the first area.

In another aspect, generating the schedules includes creating at least one of the schedules for one or more of the vehicles that are capable of self-propulsion using a plurality of different fuels such that the one or more of the vehicles change which of the different fuels is used to propel the one or more of the vehicles based on relative financial costs of refueling the different fuels in one or more areas of the transportation network.

In another aspect, generating the schedules includes creating the schedules for a plurality of rail vehicles traveling in the transportation network formed from interconnected tracks.

In another embodiment, another system includes an energy management module and a control module. The energy management module is configured to be disposed on-board a vehicle that travels in a transportation network formed from interconnected routes. The energy management module also is configured to generate a trip plan for a control unit of the vehicle that is used to control tractive efforts of the vehicle as the vehicle travels in the transportation network. The control module is configured to track an amount of fuel carried by the vehicle and to communicate the amount of fuel to a network scheduling system. The energy management module also is configured to generate the trip plan based on a schedule that is received from the network scheduling system and that is based on the amount of fuel tracked by the control module. The trip plan directs the vehicle to stop to refuel at one or more refueling locations in the transportation network based on financial costs of the fuel provided by the one or more refueling locations.

In another aspect, the energy management module is configured to generate the trip plan to reduce the fuel consumed by the vehicle when traveling through the transportation network according to the schedule relative to traveling through the transportation network according to a different schedule.

In another aspect, the energy management module is configured to generate the trip plan such that the vehicle travels to a first refueling location of the refueling locations to obtain an amount of fuel that is less than is necessary to fully refuel the vehicle and such that the vehicle travels to a second refueling location of the refueling locations to fully refuel based on a comparison of the financial costs of the fuel at the first refueling location and the second refueling location.

In another aspect, the energy management module is configured to generate the trip plan such that the vehicle fully refuels at a first refueling location of the refueling locations before an amount of fuel carried by the vehicle falls below a refueling threshold based on a comparison between the financial costs of the fuel at the first refueling location and a different, second refueling location of the refueling locations.

In another aspect, the energy management module is configured to generate the trip plan for a rail vehicle traveling in the transportation network formed from interconnected tracks.

Another embodiment relates to a method (e.g., method for scheduling and/or controlling plural rail vehicles or other vehicles) comprising determining financial costs of fuel at refueling locations within a transportation network formed of interconnected routes over which plural vehicles travel. The method further comprises communicating respective initial schedules to the vehicles for the vehicles to concurrently travel in the transportation network. (According to one aspect, prior to communication of the schedules, the schedules are automatically generated by a scheduling system.) The initial schedule for each vehicle includes a refueling stop (or stops) for the vehicle, or it may include the financial costs of the fuel at the refueling locations, among other possible information (such as a destination location, destination time, route, or the like).

According to another aspect, each vehicle generates an initial trip plan for the vehicle based in part on the refueling stop for the vehicle or the financial costs of the fuel at the refueling locations. The trip plan includes plural throttle/power settings (and possibly other settings, such as brake settings) for controlling movement of the vehicle along a route, e.g., for each of a plurality of points along the route there may be a throttle/power/brake setting, designated speed, or the like. The trip plan may be configured for automatic control of the vehicle along the route. The trip plan may be generated based on factors in addition to the refueling stop for the vehicle or financial costs, such as vehicle information, route information, trip objectives or constraints, and the like.

According to another aspect, the vehicles transmit their respective initial trip plans to an off-board location, such as to the scheduling system that generated the initial schedules. The method further comprises receiving the initial trip plans from the vehicles, and responsive to the initial trip plans, generating and communicating modified schedules to the vehicles. The modified schedules are generated based on the financial costs of the fuel at the refueling locations and on the received initial trip plans. The method may further comprise the vehicles receiving the respective modified schedules, and generating respective modified trip plans for the vehicles based on the modified schedules.

According to another aspect, when a vehicle receives a schedule, it may determine if the fuel/fueling information of the schedule meets one or more priority criteria relative to other designated trip objectives of the vehicle. The priority criteria are established for determining whether fueling costs or other fueling considerations should be given priority, when controlling the vehicle along a route, versus other possible objectives, such as reducing travel time to destination or reducing emissions. For example, if the highest priority objective for a vehicle trip (or portion thereof) is reduced emissions (due to the vehicle traveling in an area where emissions are regulated) regardless of cost, travel time, etc., then the priority criterion is that reduced emissions has the highest priority; it follows that fuel cost considerations will not meet the priority criterion. Another example is if the highest priority objective is reduced emissions except if fuel cost savings are above a designated threshold. Here, if the schedule is associated with cost savings above the designated threshold, then the fuel/fueling information of the schedule is deemed to meet one or more priority criteria relative to other designated trip objectives of the vehicle. If the fuel/fueling information of the schedule does not meet the one or more priority criteria relative to other designated trip objectives of the vehicle, a trip plan is generated for controlling the vehicle along a route based on the other designated trip objectives having priority over the refueling stop for the vehicle or other fuel information. (This may include not using the fuel information of the schedule at all in generating the trip plan, i.e., the trip plan is generated irrespective of fuel information in the schedule.) If the fuel/fueling information of the schedule meets the one or more priority criteria, the trip plan is generated based on the refueling stop for the vehicle or other fuel information being given priority over the other designated trip objectives. Information on relative weighting (priority) of factors in generating a trip plan can be seen in commonly owned U.S. Publication No. US-2007-0219680 dated Sep. 20, 2007, incorporated herein by reference.

According to another aspect, vehicle fuel information is communicated from the vehicles to the scheduling system. For example, the vehicle fuel information may be an estimation or measure of fuel remaining on the vehicle. The scheduling system is configured to use the vehicle fuel information when generating initial and/or modified schedules.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the inventive subject matter without departing from its scope. While the dimensions and types of materials described herein are intended to define the parameters of the inventive subject matter, they are by no means limiting and are exemplary embodiments. Many other embodiments will be apparent to one of ordinary skill in the art upon reviewing the above description. The scope of the inventive subject matter should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. §112, sixth paragraph, unless and until such claim limitations expressly use the phrase “means for” followed by a statement of function void of further structure.

This written description uses examples to disclose several embodiments of the inventive subject matter, including the best mode, and also to enable one of ordinary skill in the art to practice the embodiments of inventive subject matter, including making and using any devices or systems and performing any incorporated methods. The patentable scope of the inventive subject matter is defined by the claims, and may include other examples that occur to one of ordinary skill in the art. Such other examples are intended to be within the scope of the claims if they have structural elements that do not differ from the literal language of the claims, or if they include equivalent structural elements with insubstantial differences from the literal languages of the claims.

The foregoing description of certain embodiments of the present inventive subject matter will be better understood when read in conjunction with the appended drawings. To the extent that the figures illustrate diagrams of the functional blocks of various embodiments, the functional blocks are not necessarily indicative of the division between hardware circuitry. Thus, for example, one or more of the functional blocks (for example, controllers or memories) may be implemented in a single piece of hardware (for example, a general purpose signal processor, microcontroller, random access memory, hard disk, and the like). Similarly, the programs may be stand alone programs, may be incorporated as subroutines in an operating system, may be functions in an installed software package, and the like. The various embodiments are not limited to the arrangements and instrumentality shown in the drawings.

As used herein, an element or step recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising,” “comprises,” “including,” “includes,” “having,” or “has” an element or a plurality of elements having a particular property may include additional such elements not having that property.

What is claimed is:

1. A system comprising:
a scheduling module configured to generate schedules for vehicles to concurrently travel in a transportation network formed of interconnected routes over which the vehicles travel; and
a monitoring module configured to determine financial costs of fuel at refueling locations within the transportation network that are used by one or more of the vehicles to acquire additional fuel;
wherein the scheduling module is configured to coordinate the schedules of the vehicles based on the financial costs of the fuel while maintaining a throughput parameter of the transportation network above a designated nonzero threshold, the throughput parameter representative of adherence by the vehicles to the schedules as the vehicles travel through the transportation network.

2. The system of claim 1, wherein the scheduling module is configured to generate the schedules such that amounts of the fuel consumed by the vehicles as the vehicles travel in the transportation network while maintaining the throughput parameter above the threshold are less than if the vehicles traveled through the transportation network according to other schedules.

3. The system of claim 1, wherein the monitoring module is configured to determine different types of the fuel available for refueling at the refueling locations and the scheduling module is configured to generate the schedules based on the different types of the fuel at the refueling locations and on types of the fuel consumed by the vehicles.

4. The system of claim 1, wherein the scheduling module is configured to generate the schedules based on relative differences between the refueling locations and the financial costs of the fuel at the refueling locations in the transportation network.

5. The system of claim 1, wherein the monitoring module is configured to track amounts of the fuel carried by the vehicles as the vehicles travel in the transportation network, and the scheduling module is configured to generate the schedules based on the amounts of fuel carried by the vehicles, distances between locations of the vehicles and the refueling locations, and the financial costs of the fuel at the refueling locations.

6. The system of claim 1, wherein the scheduling module is configured to generate at least one of the schedules such that one or more of the vehicles travels to a first refueling location of the refueling locations to obtain an amount of fuel that is less than is necessary to fully refuel and such that the one or more of the vehicles travels to a second refueling location of the refueling locations to fully refuel based on a comparison of the financial costs of the fuel at the first refueling location and the second refueling location.

7. The system of claim 1, wherein the scheduling module is configured to generate at least one of the schedules such that one or more of the vehicles fully refuels at a first refueling location of the refueling locations before an amount of fuel carried by the one or more vehicles falls below a refueling threshold based on a comparison between the financial costs of the fuel at the first refueling location and a different, second refueling location of the refueling locations.

8. The system of claim 1, wherein the scheduling module is configured to generate at least one of the schedules such that one or more of the vehicles fully refuels at one or more of the refueling locations before an amount of fuel carried by the one or more vehicles falls below a refueling threshold when the one or more of the vehicles can refuel without reducing the throughput parameter of the transportation network to or below the threshold.

9. The system of claim 1, wherein the scheduling module is configured to delay a previously scheduled arrival time for one or more of the vehicles to arrive at a scheduled destination location when the one or more of the vehicles is traveling from a first area of the transportation network to a different, second area of the transportation network that is associated with lower financial costs of fuel relative to the first area.

10. The system of claim 1, wherein the scheduling module is configured to generate at least one of the schedules for one or more of the vehicles that are capable of self-propulsion using a plurality of different fuels such that the one or more of the vehicles change which of the different fuels is used to propel the one or more of the vehicles based on relative financial costs of refueling the different fuels in one or more areas of the transportation network.

11. The system of claim 1, wherein the scheduling module is configured to generate the schedules for a plurality of rail vehicles traveling in the transportation network formed from interconnected tracks.

12. A method comprising:
determining financial costs of fuel at refueling locations within a transportation network formed of interconnected routes over which vehicles travel; and
generating schedules for the vehicles to concurrently travel in the transportation network, one or more of the schedules including a refueling stop for one or more of the vehicles at one or more of the refueling locations;
wherein generating the schedules includes coordinating the schedules with each other based on financial costs of the fuel at the refueling locations while maintaining a throughput parameter of the transportation network above a non-zero threshold, the throughput parameter representative of adherence by the vehicles to the schedules as the vehicles travel through the transportation network.

13. The method of claim 12, wherein generating the schedules includes establishing destination locations and associated times for the vehicles in the transportation network such that amounts of the fuel consumed by the vehicles as the vehicles travel in the transportation network are less than if the vehicles traveled through the transportation network according to other schedules while maintaining the throughput parameter above the threshold.

14. The method of claim 12, further comprising determining different types of the fuel available for refueling at the refueling locations, wherein generating the schedules includes creating the schedules based on the different types of the fuel at the refueling locations and the types of the fuel consumed by the vehicles.

15. The method of claim 12, wherein generating the schedules includes creating the schedules based on relative differences between the refueling locations and the financial costs of the fuel at the refueling locations in the transportation network.

16. The method of claim 12, further comprising tracking amounts of the fuel carried by the vehicles as the vehicles travel in the transportation network, wherein generating the schedules includes creating the schedules based on the amounts of fuel carried by the vehicles, distances between locations of the vehicles and the refueling locations, and the financial costs of the fuel at the refueling locations.

17. The method of claim 12, wherein generating the schedules includes creating at least one of the schedules such that one or more of the vehicles travels to a first refueling location of the refueling locations to obtain an amount of fuel that is less than is necessary to fully refuel and such that the one or more of the vehicles travels to a second refueling location of the refueling locations to fully refuel based on a comparison of the financial costs of the fuel at the first refueling location and the second refueling location.

18. The method of claim 12, wherein generating the schedules includes creating at least one of the schedules such that one or more of the vehicles fully refuels at a first refueling location of the refueling locations before an amount of fuel carried by the one or more vehicles falls below a refueling threshold based on a comparison between the financial costs of the fuel at the first refueling location and a different, second refueling location of the refueling locations.

19. The method of claim 12, wherein generating the schedules includes creating at least one of the schedules such that one or more of the vehicles fully refuels at one or more of the refueling locations before an amount of fuel carried by the one or more vehicles falls below a refueling threshold when the one or more of the vehicles can refuel without reducing the throughput parameter of the transportation network to or below the threshold.

20. The method of claim 12, wherein generating the schedules includes moving a scheduled destination time for one or more of the vehicles to a later time when the one or more of the vehicles is traveling from a first area of the transportation network to a different, second area of the transportation network that is associated with lower financial costs of fuel relative to the first area.

21. The method of claim 12, wherein generating the schedules includes creating at least one of the schedules for one or more of the vehicles that are capable of self-propulsion using a plurality of different fuels such that the one or more of the vehicles change which of the different fuels is used to propel the one or more of the vehicles based on relative financial costs of refueling the different fuels in one or more areas of the transportation network.

22. The method of claim 12, wherein generating the schedules includes creating the schedules for a plurality of rail vehicles traveling in the transportation network formed from interconnected tracks.

23. A method comprising:
determining financial costs of fuel at refueling locations within a transportation network formed of interconnected routes over which vehicles travel; and
communicating respective initial schedules to the vehicles for the vehicles to concurrently travel in the transportation network, the initial schedules including at least one of the financial costs or refueling stops for the vehicles that are determined based on the financial costs;
receiving respective initial trip plans from the vehicles responsive to the initial schedules; and
communicating respective modified schedules of the initial schedules to the vehicles, the modified schedules generated based at least in part on the initial trip plans and the financial costs of the fuel.

24. The method of claim 23, further comprising, at each vehicle:
generating the initial trip plan for the vehicle based in part on the at least one of the financial costs or the refueling stop for the vehicle;
communicating the initial trip plan of the vehicle off-board the vehicle;
receiving the respective modified schedule for the vehicle; and
generating a modified trip plan for the vehicle based on the modified schedule.

25. The method of claim 23, wherein at least one of the initial trip plans is generated based on other trip objectives being given higher priority than the at least one of the financial costs or the refueling stops.

26. A method comprising:
receiving, at a vehicle, an initial schedule for the vehicle to concurrently travel with other vehicles in a transportation network formed of interconnected routes, the initial schedule including a refueling stop for the vehicle or other fuel information relating to one or more of plural refueling locations in the transportation network, wherein the initial schedule is received from an off-board source;
determining if the refueling stop for the vehicle or other fuel information meets one or more priority criteria relative to other designated trip objectives of the vehicle, and if not, generating a trip plan for controlling the vehicle along a route based on the other designated trip objectives having priority over the refueling stop for the vehicle or other fuel information, and if so, generating the trip plan based on the refueling stop for the vehicle or other fuel information having priority over the other designated trip objectives; and
communicating the trip plan to the off-board source.

27. A system comprising:
an energy management module configured to be disposed on-board a vehicle that travels in a transportation network formed from interconnected routes, the energy management module configured to generate a trip plan for a control unit of the vehicle that is used to control tractive efforts of the vehicle as the vehicle travels in the transportation network; and
a control module configured to track an amount of fuel carried by the vehicle and to communicate the amount of fuel to a network scheduling system;
wherein the energy management module is configured to generate the trip plan based on a schedule that is received from the network scheduling system and that is based on the amount of fuel tracked by the control module, the trip plan directing the vehicle to stop to refuel at one or more refueling locations in the transportation network based on financial costs of the fuel provided by the one or more refueling locations.

28. The system of claim 27, wherein the energy management module is configured to generate the trip plan to reduce the fuel consumed by the vehicle when traveling through the transportation network according to the schedule relative to traveling through the transportation network according to a different schedule.

29. The system of claim 27, wherein the energy management module is configured to generate the trip plan such that the vehicle travels to a first refueling location of the refueling locations to obtain an amount of fuel that is less than is necessary to fully refuel the vehicle and such that the vehicle travels to a second refueling location of the refueling locations to fully refuel based on a comparison of the financial costs of the fuel at the first refueling location and the second refueling location.

30. The system of claim 27, wherein the energy management module is configured to generate the trip plan such that the vehicle fully refuels at a first refueling location of the refueling locations before an amount of fuel carried by the vehicle falls below a refueling threshold based on a comparison between the financial costs of the fuel at the first refueling location and a different, second refueling location of the refueling locations.

31. The system of claim 27, wherein the energy management module is configured to generate the trip plan for a rail vehicle traveling in the transportation network formed from interconnected tracks.
